(19) United States
(12) Patent Application Publication
(10) Pub. No.: US 2016/0116121 A1
(43) Pub. Date: Apr. 28, 2016

(54) LED BACKLIGHT LIGHT SOURCE

(71) Applicant: SHENZHEN CHINA STAR OPTOELECTRONICS TECHNOLOGY CO. LTD., Shenzhen, Guangdong (CN)

(72) Inventors: Che-Chang HU, Shenzhen, Guangdong (CN); Yong FAN, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/008,140

(22) PCT Filed: Jul. 10, 2013
(86) PCT No.: PCT/CN2013/079130

§ 371 Date: Sep. 27, 2013

(30) Foreign Application Priority Data
Jun. 28, 2013 (CN) 201310269974.5

(51) Int. Cl. F21K 99/00; F21V 9/16

(52) U.S. Cl. CPC F21K 9/56; F21V 9/16; F21Y 2101/02; F21Y 2113/007

(57) ABSTRACT

The invention discloses an LED backlight light source, comprising at least a red chip and a blue chip, and further comprising a green quantum dot phosphor layer which is not contacted with the red chip and the blue chip and encapsulated into a same LED backlight light source together with the red chip and the blue chip. Red light and blue light emitted by the red chip and the blue chip penetrate through the green quantum dot phosphor layer for the purpose of green light compensation, respectively, to obtain white light with high NTSC, high penetration rate and high brightness.

### FIELD OF THE INVENTION

The invention relates to an LED backlight light source, in particular to an LED backlight light source combining red and blue chips and quantum dot phosphors.

### BACKGROUND OF THE INVENTION

In a color flat-panel display element of a TET-LCD, because the LCD itself does not emit light, matching of backlight light sources and RGB color filters is required to realize color display.

In the aspect of the current LED backlight, a high gamut is generally realized by using blue chips plus RG phosphors LED and increasing the thickness of the color filters. In the case of the premise of not increasing the thickness of the color filters, because the Full Width Half Magnitude (FWHM) of the emitting spectra of the current ordinary RG phosphors is generally greater than 50 nm, wherein R represents nitrides and nitrogen oxides and G represents silicates or nitrides and nitrogen oxides, the color purity is low, and the NTSC color gamut maximally realized by this manner is improved by about 20% in comparison with a manner of using blue chips plus YAG phosphors. If the thickness of the color filters is to be increased on the basis of an LED using blue chips plus ordinary RG phosphors, the penetration rate of the backlight light source after it passes through a panel will greatly decrease because the increase of the thickness of the color filters. Improving about 1% of NTSC will decrease about 1% of penetration rate and increase the use of thickness color resists.

In addition, a LCD module with LED backlight with a high gamut may also be realized by RGB chips. In this manner, because the RGB chips have different service life attenuation curves, particularly, the green chip has the fastest life attenuation, the chromaticity of the backlight light source severely changes with the prolonged lighting time of the LED. Although this manner may realize high NTSC and high penetration rate, it has high cost and is difficult to be applied in narrow-bezel apparatuses because the driving of the LED is complicated and a chromaticity feedback system is required to adjust the driving current of different color chips used in the LED.

Therefore, it is necessary to provide an LED backlight light source with high NTSC, high penetration rate and high brightness.

### SUMMARY OF THE INVENTION

In view of disadvantages of the prior art, the major purpose of the invention is to provide a high gamut and high brightness LED backlight light source combining red and blue chips and quantum dot phosphors, in order to improve the NTSC, penetration rate and brightness of the LED backlight light source.

An LED backlight light source is provided, comprising at least one red chip and one blue chip, and further comprising a green quantum dot phosphor layer which is not contacted with the red chip and the blue chip and encapsulated into a same LED backlight light source together with the red chip and the blue chip. Red light and blue light emitted by the red chip and the blue chip penetrate through the green quantum dot phosphor layer for the purpose of green light compensation, respectively, to obtain white light with high NTSC, high penetration rate and high brightness.

Preferably, the red chip and the blue chip are arranged in parallel, and peripheries of the red chip and the blue chip are wrapped with an encapsulation layer. The green quantum dot phosphor layer is mixed into an upper layer of the encapsulation layer, or stuck above the encapsulation layer. The green quantum dot phosphor layer may be arranged in the encapsulation layer or above the encapsulation layer.

In the invention, the peak wavelength of the green quantum dot phosphor layer is 525 nm-540 nm, and the Full Width Half Magnitude (FWHM) of the emitting spectra of the phosphors is 25 nm-40 nm; the peak wavelength of the blue chip is 440 nm-455 nm, and the Full Width Half Magnitude (FWHM) of the emitting spectra of the phosphors is smaller than 25 nm; and, the peak wavelength of the red chip is 625 nm-650 nm, and the Full Width Half Magnitude (FWHM) of the emitting spectra of the phosphors is smaller than 25 nm. The green quantum-dot fluorescent powder layer is made of any one or more of InP of a sole-core structure, CdSe, CdSe/ZnSe of a core-shell structure, CdSe/ZnS, CdS/ZnS, CdS/HgS, CdSe/ZnS/CdS, CdSe/CdS/ZnS, InP/CdS or InP/CdSe. The size of the green quantum dot is smaller than 15 nm. The light intensity of the red light emitted by the red chip is 0.6-1.4 (LED spectra after blue light normalization), and the light intensity of the green light emitted by the green chip is 0.25-0.5 (LED spectra after blue light normalization).

In the invention, the thickness of the green quantum dot phosphor layer is between 100 nm to 0.7 mm, and the density thereof is 1.0 g/cm³-5.0 g/cm³. The distance from the green quantum dot phosphor layer to the red chip and the blue chip is greater than 100 nm.

When the LED backlight light source of this invention is compared with the prior art, by combing luminescent red and blue chips and a green quantum dot phosphor layer together, red light and blue light emitted by the red chip and the blue chip penetrate through the green quantum-dot phosphor layer. As the FWHM of the quantum dot phosphors is narrow, the blue light excites the green quantum dot phosphors. By imitating the NTSC and penetration rate of the color filters after matched with LED spectra, in comprehensive consideration of the quantum efficiency of the human eye visual function to the red and blue chips and to the phosphors, the emission wavelength of the blue and red chips and the emission spectra of the green quantum dot phosphors are finally optimized. Such combination solution has a NTSC 50% higher than that realized by a conventional manner of combining blue chips with yellow phosphors. Furthermore, the green quantum dot phosphor has a characteristic of narrow Full Width Half Magnitude (FWHM) of emission spectra, so the emission peak wavelength may be adjusted according to the size of the quantum dot. The peak wavelength of the LED green light and red light spectra may be adjusted to be near by the peak wavelength of the penetration spectra of green and red color resists, so that the whole LED green light and red light spectra are in a spectral region with the highest color resistive penetration rate, thereby improving the penetration rate and brightness of a liquid crystal display. The penetration rate and brightness of an LED may be improved by combining red and blue chips plus green quantum dot phosphors. In addition, a design of separating a green quantum dot phosphor coating or thin film from the red and blue chips may decrease the heating temperature of the phosphors and avoid the change of color and the efficiency reduction of the phosphors, thereby realizing high NTSC of a TET-LCD module and high penetration rate of the backlight after penetrating through a panel.

### BRIEF DESCRIPTIONS OF THE DRAWINGS

FIG. 1 is spectrograms of color filters and LED spectrograms of an LED backlight light source in the invention;

FIG. 2 is a schematic diagram of an encapsulation structure in Embodiment 1 of an LED backlight light source in the invention;

FIG. 3 is a schematic diagram of an encapsulation structure in Embodiment 2 of an LED backlight light source in the invention; and

FIG. 4 is a schematic diagram of gamut coverage comparison of an LED backlight light source in the invention.

### DETAILED DESCRIPTIONS OF THE PREFERRED EMBODIMENTS

As shown in FIG. 2, an LED backlight light source 100 is provided, comprising at least one red chip 1 and one blue chip 2, and further comprising a green quantum dot phosphor layer 3 which is not contacted with the red chip 1 and the blue chip 2 and encapsulated into a same LED backlight light source 100 together with the red chip 1 and the blue chip 2.

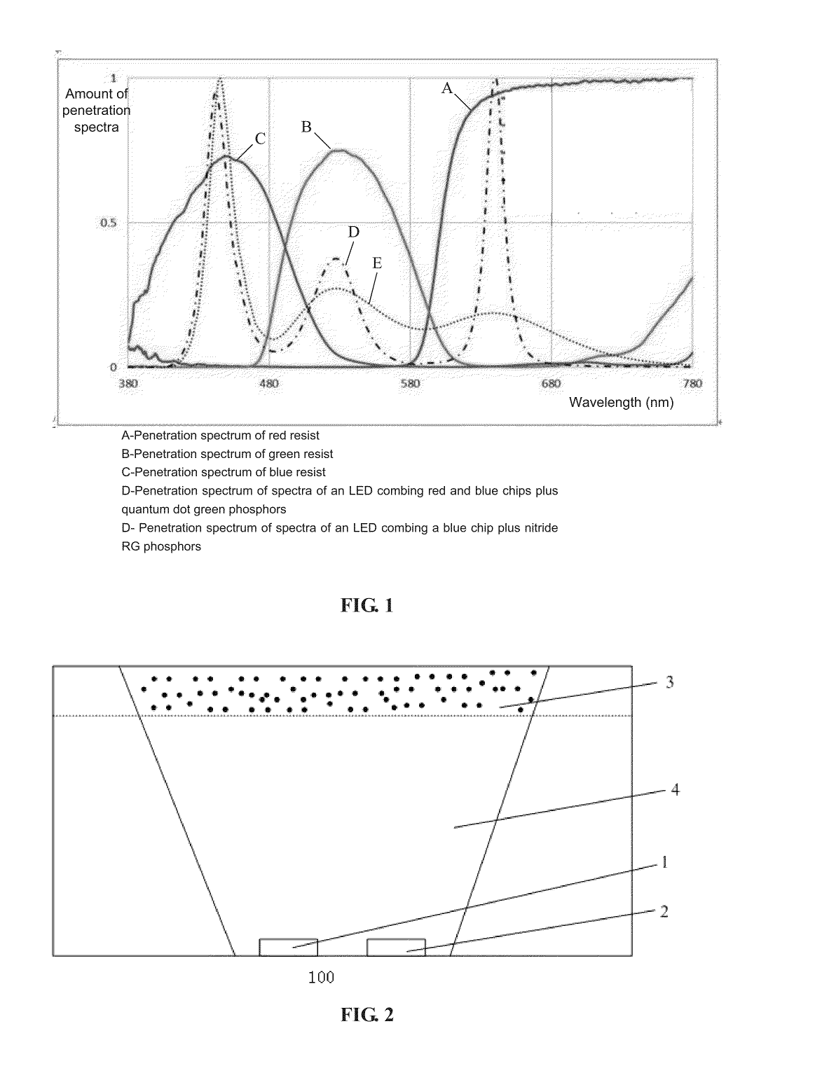

The red chip 1 and the blue chip 2 are encapsulated on the bottom of the LED backlight light source 100. The red chip 1 may emit red light, and the blue chip 2 may emit blue light. The green quantum dot phosphor layer 3 is wrapped outside the LED backlight light source. The red light with long wavelength will not excite the green quantum dot phosphors, but only the blue light may excite the green quantum dot phosphors. The green quantum dot phosphors have the following functions: on the one hand, the green quantum dot phosphors are excited by the blue light to emit green light which mixes with the blue light and the red light to form white light; on the other hand, due to narrow full width half magnitude (generally, smaller than 45 nm) and high color purity of luminescence spectra of the green quantum dot, the green phosphors may be replaced with yellow or orange phosphors if in the lighting field. The red light and blue light emitted by the red and blue chips penetrate through the green quantum dot phosphor layer 3. By imitating the NTSC (National Television System Committee) and penetration rate of the color filters after matched with LED spectra, in comprehensive consideration of the quantum efficiency of the human eye visual function to the red and blue chips and to the phosphors, the emission wavelength of the blue and red chips and the emission spectra of the green quantum dot phosphors are finally optimized, wherein NTSC represents a gamut under standards of the NTSC. The RGB spectral wavelength and intensity are adjusted via the color gamut imitation, and the brightness, NTSC and panel penetration rate are calculated. The bigger the product of these three parameters is, the better the effect is. FIG. 1 shows spectra of the color filters and LED spectra, wherein Curve A represents the penetration spectrum of a red resist, Curve B represents the penetration spectrum of a green resist, Curve C represents the penetration spectrum of a blue resist, Curve D represents the luminescence spectrum of the LED combing red and blue chips plus quantum dot green phosphors, and Curve E represents the luminescence spectrum of the LED combing blue chips plus nitride red green phosphors. The longitude ordinate represents the spectrum obtained after spectrum normalization, while the horizontal ordinate represents the wavelength. The penetration spectrum of the RGB color resists is broad. Particularly, the Curve B of the green part and the Curve A of the red part have significant influence on the gamut of the LED backlight display. When the spectrum peak of the green light is close to the penetration spectrum peak of the green resist in the LED spectra, the loss of the green light is least after penetrating the color resist. The smaller the Full Width Half Magnitude (FWHM) of the green light spectrum is, the higher the color saturation after the green light of the LED penetrates through the green resist, so the larger the gamut of the display is, so does the red light of the LED. For Curve D, in the luminescence spectrum of the LED combining red and chips plus quantum dot green phosphors, the Full Width Half Magnitude (FWHM) of both the red light and the green light is small, the FWHM of the red spectrum being smaller than 25 nm and the FWHM of the green spectrum being smaller than 45 nm. The color saturation of the LED combing red and chips plus quantum dot green phosphors after the red light and green light penetrate through the red light and green light color resists is greatly improved in comparison to the nitride RG LED, so the gamut coverage of the display is greatly improved. Meanwhile, because the energy efficiency of the red chip is higher than the energy conversion efficiency of exciting the red phosphor by the LED blue light, compared with a conventional LED using RGB chips, no complicated circuit is required for driving.

In the invention, two encapsulation manners of red and blue chips and green quantum dot phosphors are provided as below.

As shown in FIG. 2, in Embodiment 1, the red chip 1 and the blue chip 2 are arranged on the bottom of the LED backlight light source 100 in parallel. On the upper layers of the red chip 1 and the blue chip 2, the green quantum dot phosphors are mixed into an encapsulation layer 4 formed of filler gum by an encapsulation process, and then encapsulated into the LED backlight light source 100 together with the red chip and the blue chip. The LED backlight light source comprises a red and blue chip layer, an encapsulation layer 4 and a green quantum dot phosphor layer 3 in turn from inside to outside. The green quantum dot phosphor layer 3 is paved on the upper layer of the encapsulation layer 4. The red chip 1 and the blue chip 2 emit a red light source and a blue light source from the bottom of the LED backlight light source, respectively. The red light and the blue light penetrate through the green quantum dot phosphors for the purpose of light compensation. The blue light excites the green quantum dot phosphors to realize high NTSC, high penetration rate and high brightness of the liquid crystal module.

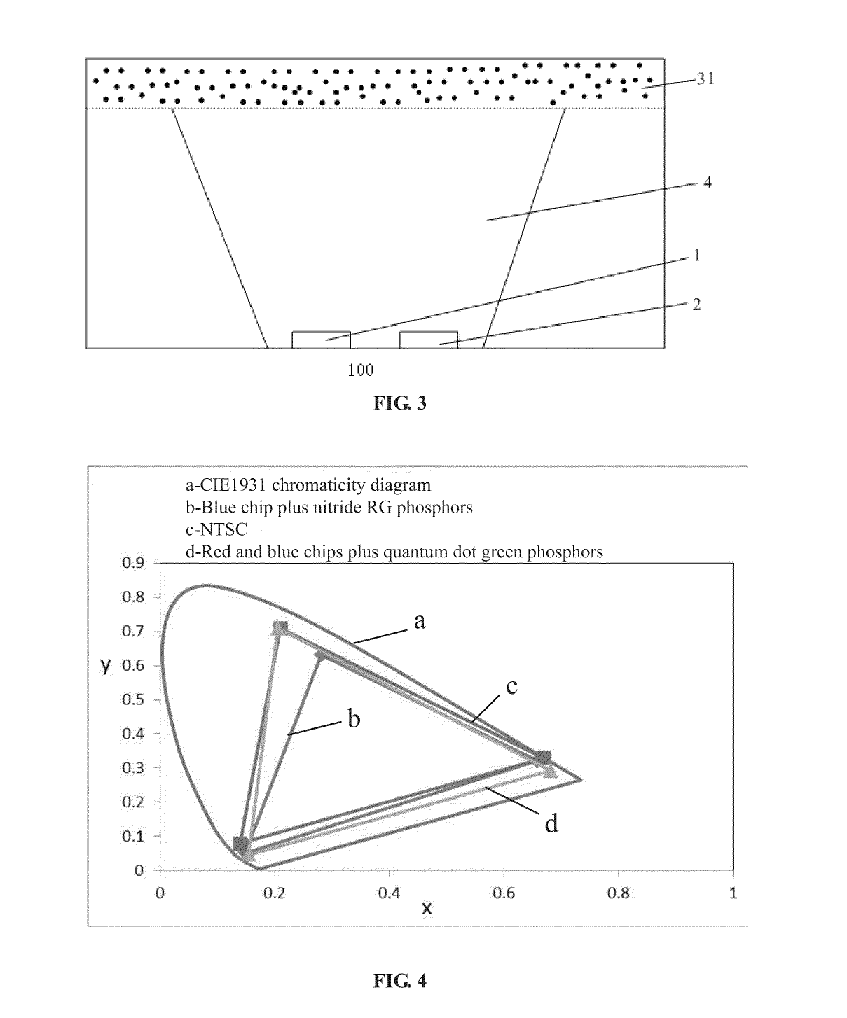

As shown in FIG. 3, in Embodiment 2, the red chip 1 and the blue chip 2 are arranged on the bottom of the LED backlight light source 100 in parallel. An encapsulation layer 4 formed of filler gum is mixed into the upper layers of the red chip 1 and the blue chip 2 by an encapsulation process, and then, the green quantum dot phosphors are embedded into a thin film to form a green quantum dot phosphor film 31. The green quantum dot phosphor film 31 is paved and stuck on the encapsulation layer 4. The LED backlight light source comprises a red and blue chip layer, an encapsulation layer 4 and a green quantum dot phosphor film 31 in turn from inside to outside.

Compared with conventional LEDs using YAG phosphors, the above settings may improve the NTCS by above 50% under the same CF conditions. Meanwhile, the penetrate rate of the liquid crystal module may be improved by 4%-8%. Furthermore, the use of color resists and the cost may be reduced.

In the invention, the peak wavelength of the green quantum dot phosphor layer is 525 nm-540 nm, and the Full Width Half Magnitude (FWHM) of the excitation spectra of the phosphors is 25 nm-40 nm; the peak wavelength of the blue chip is 440 nm-455 nm, and the Full Width Half Magnitude (FWHM) of the excitation spectra of the phosphors is smaller than 25 nm; and, the peak wavelength of the red chip is 625 nm-650 nm, and the full width half magnitude (FWHM) of the excitation spectra of the phosphors is smaller than 25 nm. The green quantum-dot fluorescent powder layer is made of any one or more of InP of a sole-core structure, CdSe, CdSe/ZnSe of a core-shell structure, CdSe/ZnS, CdS/ZnS, CdS/HgS, CdSe/ZnS/CdS, CdSe/CdS/ZnS, InP/CdS or InP/CdSe. The size of the green quantum dot is smaller than 15 nm. The light intensity of the red light emitted by the red chip is 0.6-1.4 (LED spectra after blue light normalization), and the light intensity of the green light emitted by the green chip is 0.25-0.5 (LED spectra after blue light normalization).

The thickness of the green quantum dot phosphor layer is 100 nm-0.7 mm, and the density thereof is 1.0 g/cm³-5.0 g/cm³. The distance from the green quantum dot phosphor layer to the red chip and the blue chip is greater than 100 nm. The green quantum dot phosphor layer is far away from the red chip and the blue chip in order to reduce temperature of the phosphors, in order to avoid chromatic aberration and improve the use efficiency of the phosphors. The penetration rate of the panel is mainly related to the opening ratio of the cell end, TFT, liquid crystal, CF, polarizers, and the penetration rate of glass. However, Due to different penetration rate of light with different wavelength in penetrating through glass, the calculated penetration rate of backlight with different spectrum after penetrating through a liquid crystal panel is also different. Major parameters influencing the NTSC gamut of a liquid crystal display are as follows: filtering property of RGB color resists to visible light spectra and spectral property of the backlight spectra.

The principle for improving the NTSC gamut is that the color purity of RGB three colors of a liquid crystal module is improved by using a RGB spectral light source with a narrow full width half magnitude so as to increase the NTSC gamut. FIG. 4 shows a gamut coverage region. Taking 32 inches of A05 color resist as example, the liquid crystal module has a NTSC gamut of about 82% if matched with an LED backlight combing a conventional blue chip plus nitride RG phosphors. If the backlight employs an LED combining red and blue chips plus quantum dot green phosphors, the gamut is increased to 106.5%, the gamut coverage of the liquid crystal display is thus greatly increased, so that the color reproducibility of the display becomes better and the color looks more gorgeous. Curve a presents the CIE 1931 chromaticity diagram, in which the horizontal ordinate x and the longitude ordinate y of CIE 1931 are proportionality coefficients without any unit. The whole CIE 1931 horseshoe shaped region represents all colors that may be perceived by human eyes, and each ordinate in the CIE 1931 horseshoe shaped region represents one color. Curve b represents the gamut coverage (i.e., area of a triangle surrounded by RGB) of an LCD display with an LED backlight combining a blue chip plus nitride RG phosphors. Curve c represents the coverage of a standard NTSC gamut (100%). Curve d represent the gamut coverage (i.e., area of a triangle surrounded by RGB) of an LCD display with an LED backlight combining red and blue chips plus green phosphors. Compared with Curve b, the triangle area of Curve d is greater than that of Curve b. The formula for computing the NTSC gamut is as follows: NTSC gamut=RGB gamut area of the display/NTSC standard gamut area×100%. Due to narrow full width half magnitude of the blue light and the green light spectra of the LED, the peak wavelength of the green light and red light spectra of the LED may be adjusted to be near by the peak wavelength of the penetration spectra of green and red color resists, so that the whole LED green light and red light spectra are in a spectral region with the highest color resistive penetration rate, thereby improving the penetration rate and brightness of a liquid crystal display. The penetration rate and brightness of an LED may be improved by combining red and blue chips plus green quantum dot phosphors.

What is claimed is:

1. An LED backlight light source, comprising at least a red chip and a blue chip, wherein the LED backlight light source further comprises a green quantum dot phosphor layer which is not contacted with the red chip and the blue chip and encapsulated into a same LED backlight light source together with the red chip and the blue chip, the peak wavelength of the green quantum dot is 525 nm to 540 nm, and the full width half magnitude of the excitation spectra of the phosphors is 25 nm to 40 nm; the peak wavelength of the blue chip is 440 nm to 455 nm, and the full width half magnitude of the excitation spectra of the phosphors is smaller than 25 nm; and
the peak wavelength of the red chip is 625 nm to 650 nm, and the full width half magnitude of the excitation spectra of the phosphors is smaller than 25 nm.

2. The LED backlight light source according to claim 1, wherein peripheries of the red chip and the blue chip are wrapped with an encapsulation layer.

3. The LED backlight light source according to claim 2, wherein the green quantum dot phosphor layer is mixed into an upper layer of the encapsulation layer, or stuck above the encapsulation layer.

4. The LED backlight light source according to claim 2, wherein the red chip and the blue chip are arranged in parallel.

5. The LED backlight light source according to claim 1, wherein the green quantum dot phosphor layer is made of any one or more of InP of a sole-core structure, CdSe, CdSe/ZnSe of a core-shell structure, CdSe/ZnS, CdS/ZnS, CdS/HgS, CdSe/ZnS/CdS, CdSe/CdS/ZnS, InP/CdS or InP/CdSe.

6. The LED backlight light source according to claim 1, wherein the size of the green quantum dot is smaller than 15 nm.

7. The LED backlight light source according to claim 6, wherein the light intensity of the red light emitted by the red chip is 0.6-1.4.

8. The LED backlight light source according to claim 7, wherein the light intensity of the green light emitted by the green chip is 0.25-0.5.

9. The LED backlight light source according to claim 8, wherein the thickness of the green quantum dot phosphor layer is 100 nm-0.7 mm.

10. The LED backlight light source according to claim 9, wherein the density of the green quantum dot phosphor layer is 1.0 g/cm3-5.0 g/cm3.

11. The LED backlight light source according to claim 6, wherein the distance from the green quantum dot phosphor layer to the red chip and the blue chip is greater than 100 nm.

12. An LED backlight light source, comprising at least a red chip and a blue chip, wherein the LED backlight light source further comprises a quantum dot phosphor layer which is not contacted with the red chip and the blue chip and encapsulated into a same LED backlight light source together with the red chip and the blue chip.

13. The LED backlight light source according to claim 12, wherein the peak wavelength of the green quantum dot is 525 nm to 540 nm, and the full width half magnitude of the excitation spectra of the phosphors is 25 nm to 40 nm; the peak wavelength of the blue chip is 440 nm to 455 nm, and the full width half magnitude of the excitation spectra of the phosphors is smaller than 25 nm; and, the peak wavelength of the red chip is 625 nm to 650 nm, and the Full Width Half Magnitude of the excitation spectra of the phosphors is smaller than 25 nm.

14. The LED backlight light source according to claim 12, wherein the green quantum dot phosphor layer is made of any one or more of InP of a sole-core structure, CdSe, CdSe/ZnSe of a core-shell structure, CdSe/ZnS, CdS/ZnS, CdS/HgS, CdSe/ZnS/CdS, CdSe/CdS/ZnS, InP/CdS or InP/CdSe.

15. The LED backlight light source according to claim 12, wherein the size of the green quantum dot is smaller than 15 nm.

16. The LED backlight light source according to claim 12, wherein the light intensity of the red light emitted by the red chip is 0.6-1.4.

17. The LED backlight light source according to claim 12, wherein the light intensity of the green light emitted by the green chip is 0.25-0.5.

18. The LED backlight light source according to claim 12, wherein the thickness of the green quantum dot phosphor layer is 100 nm-0.7 mm.

19. The LED backlight light source according to claim 12, wherein the density of the green quantum dot phosphor layer is 1.0 g/cm³-5.0 g/cm³.

20. The LED backlight light source according to claim 12, wherein the distance from the green quantum dot phosphor layer to the red chip and the blue chip is greater than 100 nm.
